(19) United States
(12) Patent Application Publication
(10) Pub. No.: US 2026/0121900 A1
(43) Pub. Date: Apr. 30, 2026

(54) MULTIPLEXING OF AMBIENT INTERNET OF THINGS WAVEFORM AND USER EQUIPMENT REFERENCE SIGNALS

(71) Applicant: QUALCOMM Incorporated, San Diego, CA (US)

(72) Inventors: Raviteja PATCHAVA, San Diego, CA (US); Piyush GUPTA, Bridgewater, NJ (US); Xiaoxia ZHANG, San Diego, CA (US); Ahmed Abdelaziz Ibrahim Abdelaziz ZEWAIL, San Diego, CA (US); Zhifei FAN, San Diego, CA (US); Junyi LI, Greentown, PA (US)

(21) Appl. No.: 18/934,136

(22) Filed: Oct. 31, 2024

(51) Int. Cl. H04L 27/26; H04J 3/06; H04W 28/06

(52) U.S. Cl. CPC H04L 27/2613; H04J 3/0658; H04W 28/06

(57) ABSTRACT

Various aspects of the present disclosure generally relate to wireless communication. Some aspects more specifically relate to multiplexing ambient internet of things (IoT) waveforms and user equipment (UE) reference signals. In some aspects, a network node may transmit, to an ambient IoT device and a UE, an ambient IoT waveform multiplexed with a UE reference signal. For example, the network node may transmit the ambient IoT waveform multiplexed with the UE reference signal in accordance with various implementations for multiplexing the ambient IoT waveform with the UE reference signal.

### FIELD OF THE DISCLOSURE

Aspects of the present disclosure generally relate to wireless communication and specifically relate to techniques, apparatuses, and methods associated with multiplexing ambient internet of things waveforms and user equipment reference signals.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

In some examples, a user equipment (UE) may receive a demodulation reference signal (DMRS) or another predefined reference signal that persists for an entirety of a symbol. Moreover, in some examples, an ambient IoT device may identify information from an ambient IoT waveform that has equal quantities of ‘0’ bits and ‘1’ bits in a symbol (for example, the ambient IoT device may use Manchester coding, which converts a ‘0’ bit to ‘01’ and ‘1’ bit to ‘10’). However, an ambient IoT device that detects a UE reference signal may detect ‘1’ bits for the entirety of the symbol. As a result, whether and/or how UE reference signals and ambient IoT waveforms can share the same time and/or frequency resources is unresolved.

### SUMMARY

Some aspects described herein relate to an apparatus for wireless communication at an ambient internet of things (IoT) device. The apparatus may include one or more processors. At least one processor of the one or more processors may be configured to cause the ambient IoT device to receive one or more ambient IoT control channel communications associated with multiplexing of ambient IoT waveforms and user equipment (UE) reference signals. At least one processor of the one or more processors may be configured to cause the ambient IoT device to receive, in a reference signal symbol, an ambient IoT waveform multiplexed with a UE reference signal. At least one processor of the one or more processors may be configured to cause the ambient IoT device to selectively decode the ambient IoT waveform in accordance with the one or more ambient IoT control channel communications.

Some aspects described herein relate to an apparatus for wireless communication at a UE. The apparatus may include one or more memories storing processor-executable code and one or more processors coupled with the one or more memories. At least one processor of the one or more processors may be configured to cause the UE to receive a configuration associated with multiplexing of ambient IoT waveforms and UE reference signals. At least one processor of the one or more processors may be configured to cause the UE to receive, in a reference signal symbol, an ambient IoT waveform multiplexed with a UE reference signal. At least one processor of the one or more processors may be configured to cause the UE to decode the UE reference signal in accordance with the configuration.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit one or more ambient IoT control channel communications associated with multiplexing of ambient IoT waveforms and UE reference signals. At least one processor of the one or more processors may be configured to cause the network node to transmit a configuration associated with the multiplexing of the ambient IoT waveforms and the UE reference signals. At least one processor of the one or more processors may be configured to cause the network node to transmit, in a reference signal symbol, an ambient IoT waveform multiplexed with a UE reference signal in accordance with the one or more ambient IoT control channel communications and the configuration.

Some aspects described herein relate to a method of wireless communication performed at an ambient IoT device. The method may include receiving one or more ambient IoT control channel communications associated with multiplexing of ambient IoT waveforms and UE reference signals. The method may include receiving, in a reference signal symbol, an ambient IoT waveform multiplexed with a UE reference signal. The method may include selectively decoding the ambient IoT waveform in accordance with the one or more ambient IoT control channel communications.

Some aspects described herein relate to a method of wireless communication performed at a UE. The method may include receiving a configuration associated with multiplexing of ambient IoT waveforms and UE reference signals. The method may include receiving, in a reference signal symbol, an ambient IoT waveform multiplexed with a UE reference signal. The method may include decoding the UE reference signal in accordance with the configuration.

Some aspects described herein relate to a method of wireless communication performed at a network node. The method may include transmitting one or more ambient IoT control channel communications associated with multiplexing of ambient IoT waveforms and UE reference signals. The method may include transmitting a configuration associated with the multiplexing of the ambient IoT waveforms and the UE reference signals. The method may include transmitting, in a reference signal symbol, an ambient IoT waveform multiplexed with a UE reference signal in accordance with the one or more ambient IoT control channel communications and the configuration.

Some aspects described herein relate to an apparatus for wireless communication. The apparatus may include means for receiving one or more ambient IoT control channel communications associated with multiplexing of ambient IoT waveforms and UE reference signals. The apparatus may include means for receiving, in a reference signal symbol, an ambient IoT waveform multiplexed with a UE reference signal. The apparatus may include means for selectively decoding the ambient IoT waveform in accordance with the one or more ambient IoT control channel communications.

Some aspects described herein relate to an apparatus for wireless communication. The apparatus may include means for receiving a configuration associated with multiplexing of ambient IoT waveforms and UE reference signals. The apparatus may include means for receiving, in a reference signal symbol, an ambient IoT waveform multiplexed with a UE reference signal. The apparatus may include means for decoding the UE reference signal in accordance with the configuration.

Some aspects described herein relate to an apparatus for wireless communication. The apparatus may include means for transmitting one or more ambient IoT control channel communications associated with multiplexing of ambient IoT waveforms and UE reference signals. The apparatus may include means for transmitting a configuration associated with the multiplexing of the ambient IoT waveforms and the UE reference signals. The apparatus may include means for transmitting, in a reference signal symbol, an ambient IoT waveform multiplexed with a UE reference signal in accordance with the one or more ambient IoT control channel communications and the configuration.

Some aspects described herein relate to a non-transitory computer-readable medium that stores a set of instructions for wireless communication by an ambient IoT device. The set of instructions, when executed by one or more processors of an ambient IoT device, may cause the ambient IoT device to receive one or more ambient IoT control channel communications associated with multiplexing of ambient IoT waveforms and UE reference signals. The set of instructions, when executed by one or more processors of the ambient IoT device, may cause the ambient IoT device to receive, in a reference signal symbol, an ambient IoT waveform multiplexed with a UE reference signal. The set of instructions, when executed by one or more processors of the ambient IoT device, may cause the ambient IoT device to selectively decode the ambient IoT waveform in accordance with the one or more ambient IoT control channel communications.

Some aspects described herein relate to a non-transitory computer-readable medium that stores a set of instructions for wireless communication by a UE. The set of instructions, when executed by one or more processors of the UE, may cause the UE to receive a configuration associated with multiplexing of ambient IoT waveforms and UE reference signals. The set of instructions, when executed by one or more processors of the UE, may cause the UE to receive, in a reference signal symbol, an ambient IoT waveform multiplexed with a UE reference signal. The set of instructions, when executed by one or more processors of the UE, may cause the UE to decode the UE reference signal in accordance with the configuration.

Some aspects described herein relate to a non-transitory computer-readable medium that stores a set of instructions for wireless communication by a network node. The set of instructions, when executed by one or more processors of the network node, may cause the network node to transmit one or more ambient IoT control channel communications associated with multiplexing of ambient IoT waveforms and UE reference signals. The set of instructions, when executed by one or more processors of the network node, may cause the network node to transmit a configuration associated with the multiplexing of the ambient IoT waveforms and the UE reference signals. The set of instructions, when executed by one or more processors of the network node, may cause the network node to transmit, in a reference signal symbol, an ambient IoT waveform multiplexed with a UE reference signal in accordance with the one or more ambient IoT control channel communications and the configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example associated with backscatter communications, in accordance with the present disclosure.

FIG. 3 is a diagram illustrating an example associated with envelope tracking, in accordance with the present disclosure.

FIG. 4 is a diagram illustrating an example associated with data multiplexing, in accordance with the present disclosure.

FIG. 5 is a diagram illustrating an example associated with data multiplexing using discrete Fourier transform spread waveforms, in accordance with the present disclosure.

FIG. 6 is a diagram illustrating an example associated with signaling for multiplexing ambient internet of things (IoT) waveforms and user equipment (UE) reference signals, in accordance with the present disclosure.

FIG. 7 is a diagram illustrating an example associated with a first implementation for multiplexing ambient IoT waveforms and UE reference signals, in accordance with the present disclosure.

FIG. 8 is a diagram illustrating an example associated with a second implementation for multiplexing ambient IoT waveforms and UE reference signals, in accordance with the present disclosure.

FIG. 9 is a diagram illustrating an example associated with a third implementation for multiplexing ambient IoT waveforms and UE reference signals, in accordance with the present disclosure.

FIG. 10 is a flowchart illustrating an example process performed, for example, at an ambient IoT device or an apparatus of an ambient IoT device that supports multiplexing of ambient IoT waveforms and UE reference signals, in accordance with the present disclosure.

FIG. 11 is a flowchart illustrating an example process performed, for example, at a UE or an apparatus of a UE that supports multiplexing of ambient IoT waveforms and UE reference signals, in accordance with the present disclosure.

FIG. 12 is a flowchart illustrating an example process performed, for example, at a network node or an apparatus of a network node that supports multiplexing of ambient IoT waveforms and UE reference signals, in accordance with the present disclosure.

FIG. 13 is a diagram of an example apparatus for wireless communication, such as an ambient IoT device or an apparatus of an ambient IoT device, that supports multiplexing of ambient IoT waveforms and UE reference signals, in accordance with the present disclosure.

FIG. 14 is a diagram of an example apparatus for wireless communication, such as a UE or an apparatus of a UE, that supports multiplexing of ambient IoT waveforms and UE reference signals, in accordance with the present disclosure.

FIG. 15 is a diagram of an example apparatus for wireless communication, such as a network node or an apparatus of a network node, that supports multiplexing of ambient IoT waveforms and UE reference signals, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Ambient internet of things (IoT) devices may be low-complexity devices or terminals, such as radio frequency identification (RFID) devices, tags, or sensors, among other examples. In some examples, an ambient IoT device may operate using ambient signaling (for example, incident radio frequency (RF) sources) received from a reader (for example, a network node or a user equipment (UE), among other examples). For example, the ambient IoT device may backscatter an incident signal to send data to the reader. In some examples, an ambient IoT device may employ an on-off keying (OOK) modulation scheme by performing envelope detection on a received signal (for example, by comparing an accumulated power over an entire symbol duration) to detect either a ‘0’ bit or a ‘1’ bit.

In some examples, UE reference signal symbols for discrete Fourier transform spread (DFT-s) waveforms follow orthogonal frequency-division multiplexing (OFDM) waveform design and, as a result, may persist for an entirety of a UE reference signal symbol time duration. Thus, an ambient IoT device that receives a UE reference signal would detect ‘1’ bits for the entire reference signal symbol. However, OOK waveforms may use Manchester coding, which converts a ‘0’ bit to ‘01’ and ‘1’ bit to ‘10.’ In Manchester coding, the total length of on durations in an OFDM symbol may be equal to a total length of off durations in the OFDM symbol. As a result, multiplexing of UE reference signals (which may require an on duration length that is equal to an entirety of an OFDM symbol) and ambient IoT waveforms, such as OOK waveforms (which may require equal on duration lengths and off duration lengths in an OFDM symbol) is unresolved and, thus, may inhibit network communications to ambient IoT devices and UEs. For example, the same time and/or frequency resources may be unable to carry an ambient IoT communication and a UE reference signal.

Various aspects relate generally to multiplexing ambient IoT waveforms and UE reference signals. Some aspects more specifically relate to various implementations for UE reference signal transmission using a DFT-s multiplexed scheme. In some aspects, a network node may transmit, to an ambient IoT device and a UE, an ambient IoT waveform multiplexed with a UE reference signal. For example, the network node may transmit the ambient IoT waveform multiplexed with the UE reference signal in accordance with a first implementation, a second implementation, or a third implementation for multiplexing the ambient IoT waveform with the UE reference signal.

In the first implementation, the UE reference signal may be transmitted in an entire reference signal symbol, and the ambient IoT waveform may include ‘1’ bits for an entire duration of the reference signal symbol. For example, the ambient IoT waveform may include no ambient IoT information. In some examples, the network node may transmit an ambient IoT clock recovery signal after the multiplexed ambient IoT waveform.

In the second implementation, the UE reference signal may be transmitted in one or more portions of the reference signal symbol, and the ambient IoT waveform may include both ‘0 ’ and ‘1’ bits. For example, the UE reference signal may be transmitted in the same time and/or frequency resources as the ‘1’ bit(s) of the ambient IoT waveform.

In the third implementation, after transmitting the ambient IoT waveform multiplexed with the UE reference signal in accordance with the second implementation, the network node may transmit another ambient IoT waveform multiplexed with the UE reference signal. The other ambient IoT waveform may include a sequence of bits that is reversed, as compared to a sequence of bits conveyed by the ambient IoT waveform (for example, if the sequence of bits conveyed by the ambient IoT waveform is ‘1010,’ then the sequence of bits conveyed by the other ambient IoT waveform may be ‘0101’).

Particular aspects of the subject matter described in this disclosure can be implemented to realize one or more of the following potential advantages. In some examples, the described techniques can be used to enable the network node to serve the ambient IoT device and the UE during the same time period. For example, the network node may use the same time and/or frequency resources to carry a communication to the ambient IoT device (for ambient, the ambient IoT waveform) and a UE reference signal to the UE.

The first implementation may enable the UE to process the UE reference signal without introducing additional complexity.

The second implementation may help to conserve time and/or frequency resources by enabling the network node to skip transmission of the clock recovery signal. For example, the UE reference signal may align with Manchester coding, allowing ambient IoT data to be transmitted in the reference signal symbol with no rate loss for the ambient IoT device.

The third implementation may help to improve UE reference signal transmission and/or reduce a quantity of retransmissions of the UE reference signal. For example, if the UE reference signal is a DMRS, then the channel estimation accuracy for certain subcarriers may improve.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

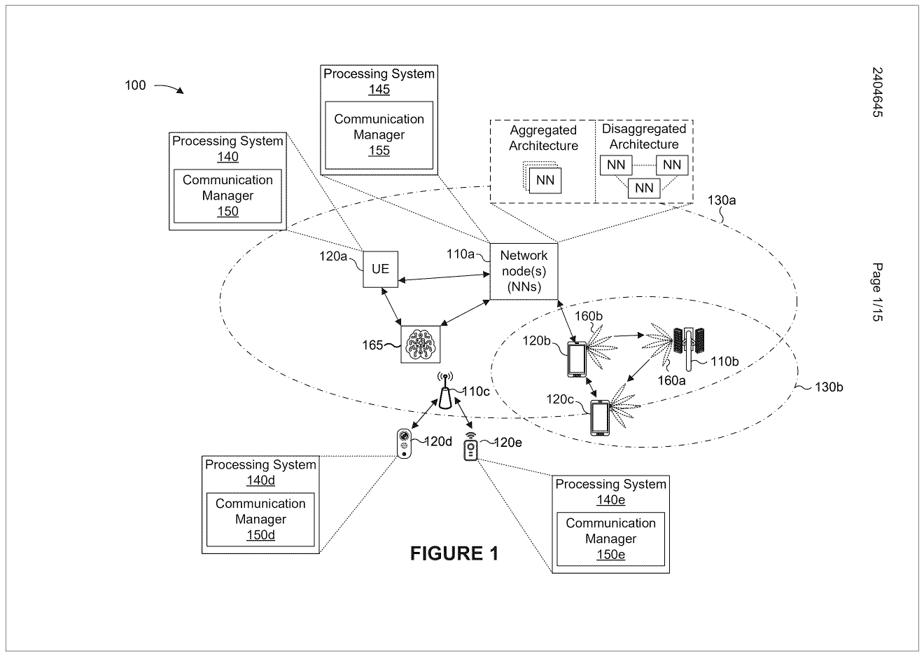

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c.

The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a DFT-s OFDM waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples.

The AI/ML model(s) may support operational decisions relating to one or more aspects associated with wireless communications devices, networks, or services.

Some IoT devices, such as ambient IoT (A-IoT) devices (sometimes referred to as ultra-light IoT devices), may be associated with a relatively simple hardware design that may be designed to use low power and be implementable at low cost. UEs 120d and 120e may be A-IoT devices. A-IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications.

In some aspects, the ambient IoT device 120d or 120e may include a communication manager 150d or 150e. As described in more detail elsewhere herein, the communication manager 150d or 150e may receive one or more ambient IoT control channel communications associated with multiplexing of ambient IoT waveforms and UE reference signals; receive, in a reference signal symbol, an ambient IoT waveform multiplexed with a UE reference signal; and selectively decode the ambient IoT waveform in accordance with the one or more ambient IoT control channel communications. Additionally or alternatively, the communication manager 150d or 150e may perform one or more other operations described herein.

In some aspects, the UE 120 may include a communication manager 150. As described in more detail elsewhere herein, the communication manager 150 may receive a configuration associated with multiplexing of ambient IoT waveforms and UE reference signals; receive, in a reference signal symbol, an ambient IoT waveform multiplexed with a UE reference signal; and decode the UE reference signal in accordance with the configuration. Additionally or alternatively, the communication manager 150 may perform one or more other operations described herein.

In some aspects, the network node 110 may include a communication manager 155. As described in more detail elsewhere herein, the communication manager 155 may transmit one or more ambient IoT control channel communications associated with multiplexing of ambient IoT waveforms and UE reference signals; transmit a configuration associated with the multiplexing of the ambient IoT waveforms and the UE reference signals; and transmit, in a reference signal symbol, an ambient IoT waveform multiplexed with a UE reference signal in accordance with the one or more ambient IoT control channel communications and the configuration. Additionally or alternatively, the communication manager 155 may perform one or more other operations described herein.

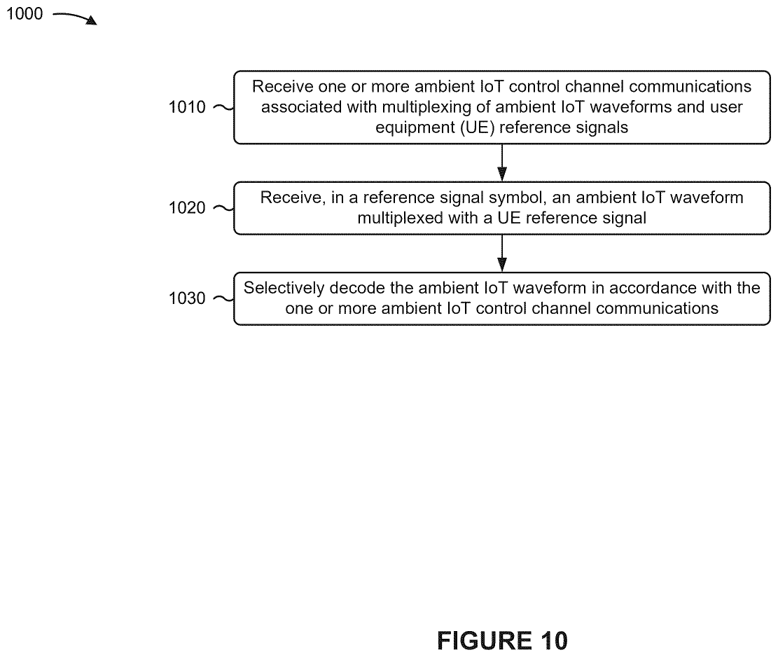

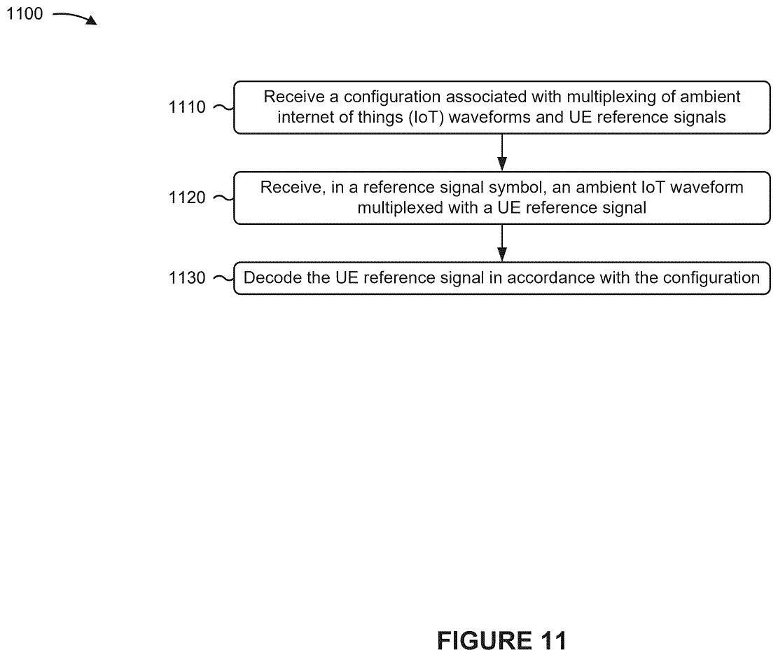

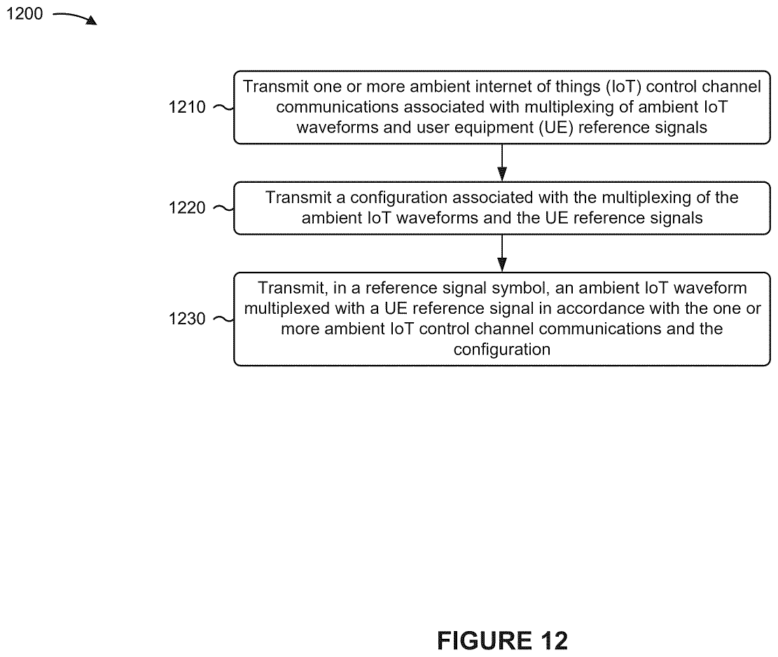

The network node 110, the processing system 145 of the network node 110, the UE 120, the processing system 140 of the UE 120, a processing system 140d or 140e of the ambient IoT device 120d or 120e, the ambient IoT device 120d or 120e, or any other component(s) of FIG. 1 may implement one or more techniques or perform one or more operations associated with multiplexing of ambient IoT waveforms and UE reference signals, as described in more detail elsewhere herein. For example, the processing system 145 of the network node 110, the processing system 140 of the UE 120, and/or the processing system 140d or 140e of the ambient IoT device 120d or 120e, may perform or direct operations of, for example, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145, the processing system 140, or the processing system 140d or 140e) of the network node 110, the UE 120, or the ambient IoT device 120d or 120e, may cause the one or more processors to perform process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples. In some aspects, the ambient IoT device 120d or 120e described herein is the UE 120, is included in the UE 120, or includes one or more components of the UE 120 shown in FIG. 1.

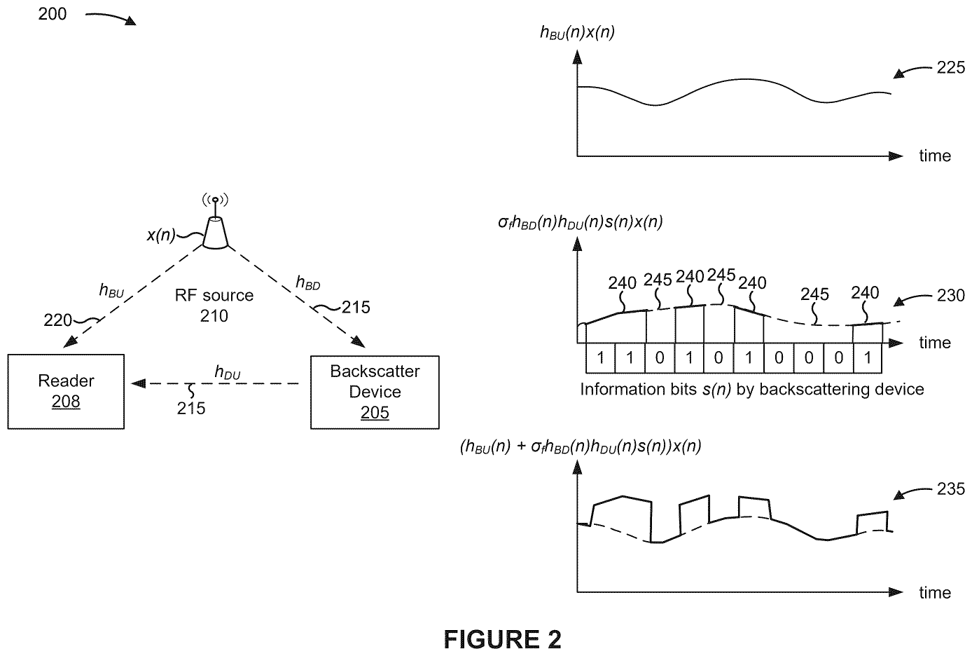

FIG. 2 is a diagram illustrating an example 200 associated with backscatter communications.

Some wireless communication devices may be considered IoT devices, such as ambient IoT devices (sometimes referred to as ultra-light IoT devices), or similar IoT devices. In ambient IoT, a terminal (for example, an RFID device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 2, a backscatter device 205 (for example, a tag or a sensor, among other examples), which may be one example of an ambient IoT device, may employ a simplified hardware design (for example, including a power splitter, an energy harvester, and a microcontroller) that does not include a battery, such that the backscatter device 205 relies on energy harvesting for power, and that does not include a radio wave generation circuit, such that the backscatter device 205 is capable of transmitting information only by reflecting a radio wave. More particularly, the backscatter device 205 communicates with a reader 208 (for example, a UE 120, a network node 110, or another network device) by modulating a reflecting radio signal from an RF source 210 (for example, a network node 110, a UE 120, or another network device). In some examples, the RF source 210 and the reader 208 may be the same device and/or may be co-located. For example, in some instances, the reader 208 and the RF source 210 may be associated with the same network node 110.

To facilitate communication of the backscatter device 205, the RF source 210 may transmit an energy harvesting wave to the backscatter device 205. The energy harvesting wave may be transmitted for a sufficient duration in order to enable a communication phase for a target range between the reader 208 and the backscatter device 205. Additionally or alternatively, in some instances, a range between the RF source 210 and the backscatter device 205 may be limited by a minimum received power for triggering energy harvesting at the backscatter device 205, such as-20 decibel milliwatts (dBm).

Once energy is sufficiently accumulated at the backscatter device 205, the backscatter device 205 may begin to reflect the radio wave that is radiated onto the backscatter device 205 via a backward link 215 (for example, a backscatter link). For example, the RF source 210 may initiate a communication session (sometimes referred to as a query-response communication) with a query, which may be a modulating envelope of a carrier wave. The backscatter device 205 may respond by backscattering of the carrier wave. The communication session may include multiple rounds, such as for purposes of contention resolution when multiple backscatter devices respond to a query. A channel between the RF source 210 and the backscatter device 205 of the backward link 215 may be associated with a first backward link channel response value (sometimes referred to as a first backward link channel coefficient or a first backward link gain value), hBD. As described below, the backscatter device 205 may have reflection-on periods and reflection-off periods that follow a pattern that is based at least in part on the transmission of information bits by the backscatter device 205. The reader 208 may detect the reflection pattern of the backscatter device 205 and obtain the backscatter communication information via the backward link 215. A channel between the reader 208 and the backscatter device 205 of the backward link 215 may be associated with a second backward link channel response value (sometimes referred to as a second backward link channel coefficient or a second backward link channel gain value), hDU. In addition, the RF source 210 and the reader 208 may communicate (for example, reference signals and/or data signals) via a direct link 220. A channel between the RF source 210 and the reader 208 of the direct link 220 may be associated with a direct link channel response value (sometimes referred to as a direct link channel coefficient or a direct link channel gain value), hBU.

The backscatter device 205 may use an information modulation scheme, such as amplitude shift keying (ASK) modulation or OOK modulation. For ASK or OOK modulation, the backscatter device 205 may switch on reflection when transmitting an information bit “1” and switch off reflection when transmitting an information bit “0. ” In backscatter communication, the RF source 210 may transmit a particular radio wave (for example, a reference signal or a data signal, such as a PDSCH), which may be denoted as x(n). The reader 208 may receive this radio wave, x(n), directly from the RF source 210 via the direct link 220, as well as from the backscatter device 205 modulating and reflecting the radio wave to the reader 208 via the backward link 215.

The signal received at the reader 208 via the direct link 220, indicated by reference number 225, is the product of the radio wave transmitted by the RF source 210, x(n), multiplied by the direct link channel response value, hBU, plus any signal noise. The information bits signal of the backscatter device 205 may be denoted as s(n) where s(n)∈{0,1}. Accordingly, the signal received at the reader 208 via the backward link 215, indicated by reference number 230, is the product of the signal transmitted by the RF source 210, x(n), multiplied by the first backward link channel response value, hBD, the second backward link channel response value, hDU, the information bits signal from the backscatter device 205, s(n), and a reflection coefficient associated with the backscatter device 205 plus any noise.

Thus, the resulting signal received at the reader 208, which is the superposition of the signal received via the direct link 220 and the signal received via the backward link 215, may be denoted as y(n). This signal, y(n), is shown by reference number 235. As shown, when s(n)=0 (indicated by reference number 240 in the plot shown at reference number 230), the backscatter device 205 may switch off reflection, and thus the reader 208 receives only the direct link 220 signal. When s(n)=1 (indicated by reference number 245 in the plot shown at reference number 230), the backscatter device 205 may switch on reflection, and thus the reader 208 receives a superposition of both the direct link 220 signal and the backward link 215 signal. To receive the information bits transmitted by the backscatter device 205, the reader 208 may first decode x(n) based at least in part on the direct link channel response value of h_BU (n) by treating the backward link 215 signal as interference. The reader 208 may then detect the existence of the signal component. In some instances, the backscatter device 205 may not maintain a state from communication session to communication session except of what is stored in the backscatter device 205 memory, such as an electronic product code (EPC) associated with backscatter device 205 or similar information.

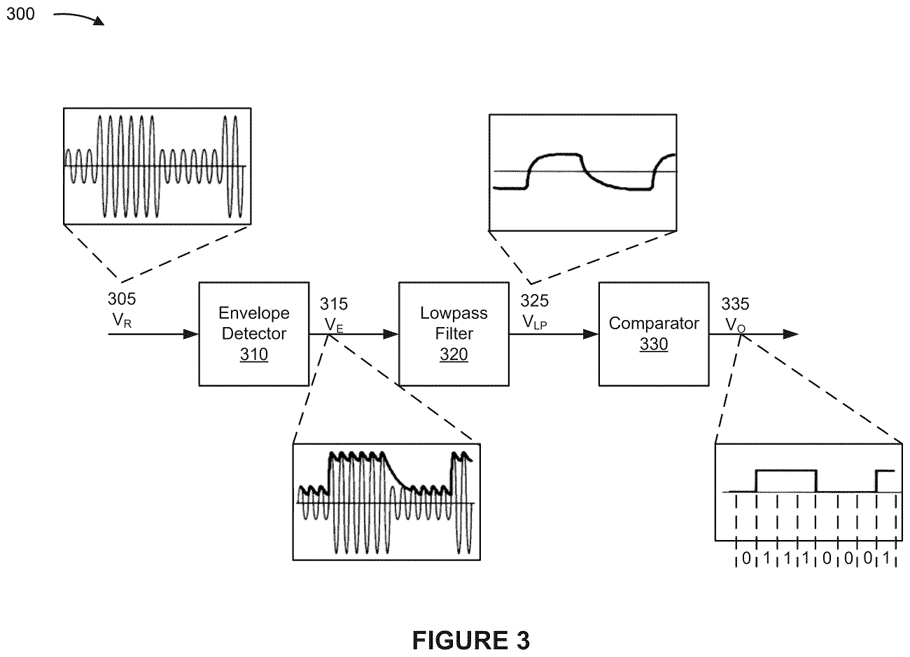

FIG. 3 is a diagram illustrating an example 300 associated with envelope tracking, in accordance with the present disclosure. The operations described and depicted in connection with FIG. 3 may be performed by a network entity, such as an ambient IoT device, a tag (for example, an RFID tag), a sensor, a passive device, a passive IoT device, a semi-passive device, an active device, a RedCap network entity, a low-tier network entity, an NR-Lite network entity, and/or a UE, among other examples, that is associated with reduced RF capabilities. For example, the network entity may not include active RF components, such as an oscillator (for example, a local oscillator), a power amplifier, a low noise amplifier, a mixer, and/or other RF components.

Envelope tracking may be used by the network entity to decode wireless signals, such as a wireless signal transmitted via a forward link or a downlink. For example, envelope tracking can be used as a technique to detect and extract a modulated signal. Envelope tracking may be utilized by the network entity as a form of signal demodulation that can recover a baseband signal from a modulated RF signal. For example, the network entity may receive a signal 305 having a received voltage (V_{R}) over time. For example, an amplitude of the signal may vary over time, as shown in FIG. 3.

The network entity may provide the signal (or information associated with the signal) to an envelope detector 310 (for example, an envelope tracker). The envelope detector 310 may be configured to detect an envelope 315 associated with the signal 305. In some examples, the envelope detector 310 may be configured to detect an upper envelope of the signal 305. The upper envelope may be a waveform indicating the upper extremes of the amplitude of the signal 305 over time. For example, the envelope of the signal 305 may be represented by the bold waveform shown in FIG. 3. The envelope 315 may be associated with an envelope voltage (V_{E}) indicating a voltage of the envelope 315 over time.

The network entity may provide the envelope 315 and/or the envelope voltage (V_{E}) to a lowpass filter 320. The lowpass filter 320 may be associated with filtering frequencies that are above a frequency threshold. For example, the lowpass filter 320 may allow signals with a lower frequency to pass through, while blocking signals with higher frequencies (for example, above the frequency threshold). The network entity may provide the envelope 315 and/or the envelope voltage (V_{E}) to the lowpass filter 320 to extract a baseband signal associated with the signal 305. The lowpass filter 320 removes high-frequency components of the signal 305, leaving only a filtered signal 325 at the output of the lowpass filter 320. The filtered signal 325 having a voltage (V_{LP}) over time can then be further processed, as described herein.

For example, the network entity may provide the filtered signal 325 having a voltage (V_{LP}) over time to a comparator 330. The comparator 330 may be a component configured to determine whether a voltage (V_{O}) of a signal at a given time is to be associated with a “1” or a “0” (for example, for information bits of the signal 305). For example, the comparator 330 may compare a voltage of the filtered signal 325 to one or more thresholds. As an example, if a value of a voltage at a given time satisfies a threshold, the comparator 330 may determine that the filtered signal 325 is associated with a “1” at the given time. If a value of a voltage at a given time does not satisfy the threshold, the comparator 330 may determine that the filtered signal 325 is associated with a “0” at the given time. The comparator 330 may provide an output 335 with voltages (V_{O}) that are indicative of a “1” or a “0” for respective information bits of the signal 305.

As shown in FIG. 3, the network entity may decode the information bits (for example, a series of “1” and/or “0”) based on the output of the comparator 330. For example, for a time window (for example, a given amount of time), the network entity may determine whether the output 335 of the comparator indicates a “0” or a “1”. The network entity may determine that a bit (for example, associated with the time window) is associated with a “0” or a “1” based on, in accordance with, or otherwise associated with the output 335 of the comparator 330. As a result, a decoding operation performed by the network entity may be simplified and/or associated with reduced complexity. For example, the network entity is enabled to obtain values of the information bits of the signal 305 without using one or more active RF components. Additionally, the network entity is enabled to obtain values of the information bits of the signal 305 without down-converting the signal 305 to a baseband signal. As another example, the envelope tracking decoding operation enables the network entity to obtain values of the information bits of the signal 305 without performing a carrier frequency offset and/or frequency synchronization.

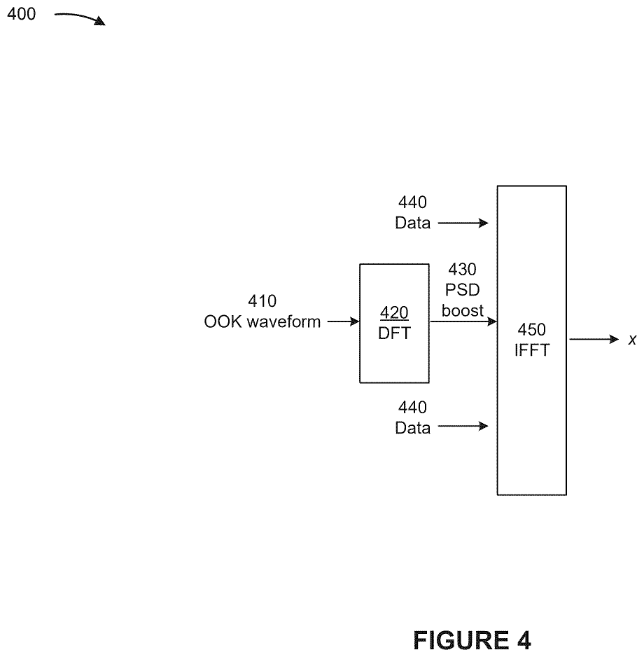

FIG. 4 is a diagram illustrating an example 400 associated with data multiplexing, in accordance with the present disclosure.

In some examples, an ambient IoT device may receive an OOK waveform via a forward link. The OOK waveform may be generated using an OFDM waveform and may be multiplexed with UE data signals (for example, data transmissions for which a UE having one or more active RF components is a target recipient). In some examples, a UE data signal may be multiplexed with an OOK waveform using time division multiplexing (TDM), which can result in spectral efficiency loss.

In some examples, a UE data signal may be multiplexed with an OOK waveform by applying a power spectral density (PSD) boost to the OOK waveform. As shown in example 400, a network node may generate an OOK waveform 410, apply a discrete Fourier transform (DFT) 420 to the OOK waveform 410, and apply a PSD boost 430 to the transformed OOK waveform. The network node may also obtain data 440 for a UE data signal, and apply an IFFT 450 to the PSD-boosted OOK waveform and the data 440 to generate a multiplexed signal x.

Example 400 may effectively utilize frequency resources, and the PSD boost 430 may enable narrowband IoT devices (which may not have RF filters) to decode the OOK waveform. However, the PSD boost 430 (which may be on the order of tens of dBs) may cause the power of the UE data signal to be reduced, thereby leading to low signal-to-noise-ratio (SNR) and/or high throughput loss for the UE data signal.

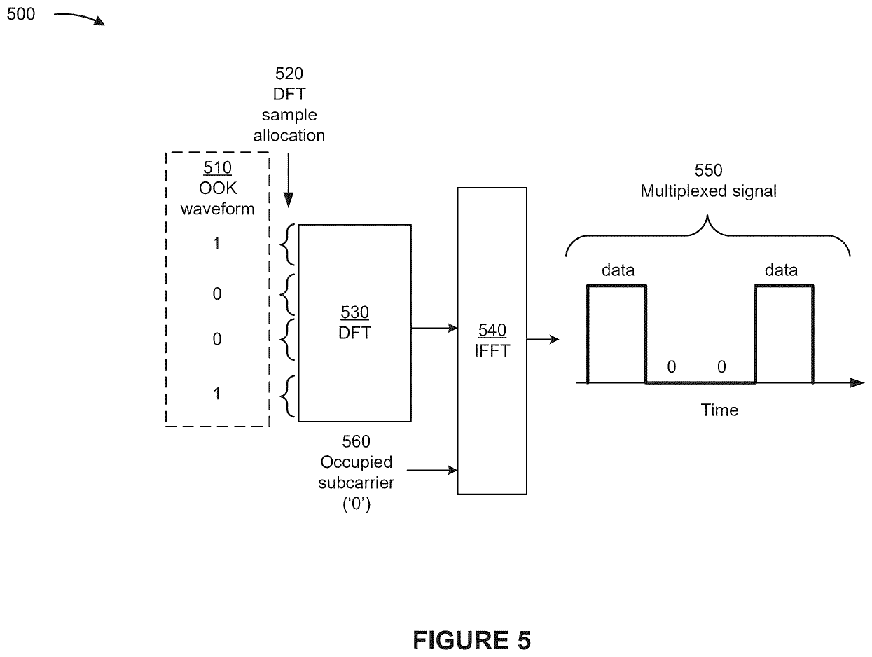

FIG. 5 is a diagram illustrating an example 500 associated with data multiplexing using DFT-s waveforms, in accordance with the present disclosure.

In example 500, the network node may modify a UE data signal (for example, a UE data waveform) such that the UE data signal follows a pattern of the OOK waveform for the duration of an OFDM symbol. For example, the network node may multiplex the UE data signal with an OOK waveform using a DFT-s waveform by placing QAM symbols in an on duration of the OOK waveform (and not placing QAM symbols in an off duration of the OOK waveform).

As shown in example 500, a network node may generate and fix an OOK waveform 510 to an ambient IoT waveform. In this example, the OOK waveform contains the following pattern of bits: 1, 0, 0, 1. The network node may divide a DFT sample allocation 520 for a UE into subsets of symbols, each subset corresponding to a one-symbol duration of the ambient IoT OOK waveform in the time domain. For example, if the OOK waveform has four symbols for one OFDM duration, and 1024 subcarriers are allocated for the UE data signal, then each OOK symbol duration may correspond to 1024/4=256 samples in the pre-DFT domain for data. The network node may allocate (for example, place) UE data (for example, random data) in only the on durations of the OOK symbols, and not in the off durations. The network node may apply a DFT 530 and an IFFT 540 in accordance with the allocation to generate a multiplexed signal 550. As shown, the IFFT 540 may involve one or more occupied subcarriers, such as occupied subcarrier 560.

Upon receiving the multiplexed signal 550, an ambient IoT device may perform envelope detection by comparing an accumulated power over respective symbol durations to detect either a ‘0’ bit or a ‘1’ bit. As a result, any phase and/or amplitude variation within a given on (for example, ‘1’ bit) duration may not affect the performance of the envelope detection. Thus, the multiplexed signal 550 may embed information (for example, the UE data) in the on durations of the OOK symbols using phase and/or amplitude variation without impacting envelope detection performance.

In some examples, the UE data signal may be a UE reference signal, such as a DMRS. Currently, reference signal symbols for DFT-s waveforms follow OFDM waveform design and, as a result, remain on for an entirety of a UE reference signal symbol time duration. Thus, an OOK waveform multiplexed with such a UE reference signal would include ‘1’ bits for the entire reference signal symbol. However, OOK waveforms may use Manchester coding, which converts a ‘0’ bit to ‘01’ and ‘1’ bit to ‘10.’ In Manchester coding, the total length of on durations in an OFDM symbol may be equal to a total length of off durations in the OFDM symbol. As a result, multiplexing of UE reference signals (which may require an on duration length that is equal to an entirety of an OFDM symbol) and ambient IoT waveforms, such as OOK waveforms (which may require equal on duration lengths and off duration lengths in an OFDM symbol) is unresolved and, thus, may inhibit network communications to ambient IoT devices and UEs. For example, the same time and/or frequency resources may be unable to carry an ambient IoT communication and a UE reference signal.

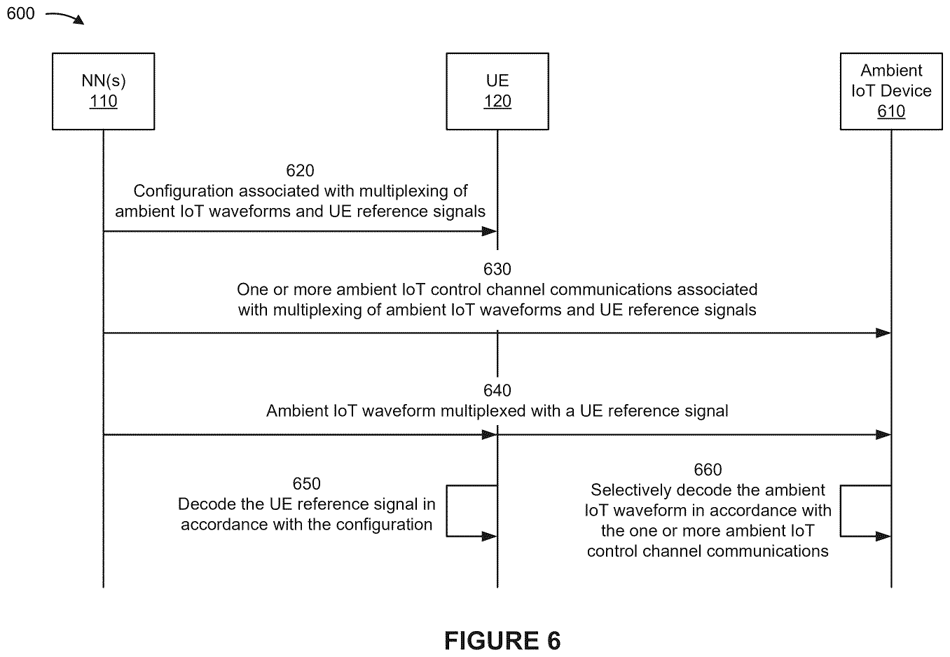

FIG. 6 is a diagram illustrating an example 600 associated with signaling for multiplexing ambient IoT waveforms and UE reference signals, in accordance with the present disclosure. As shown in FIG. 6, a network node 110, a UE 120, and an ambient IoT device 610 (for example, UE 120d or 120e, the backscatter device 205, or an ambient IoT device discussed above in connection with FIGS. 3-5, among other examples) may communicate with one another.

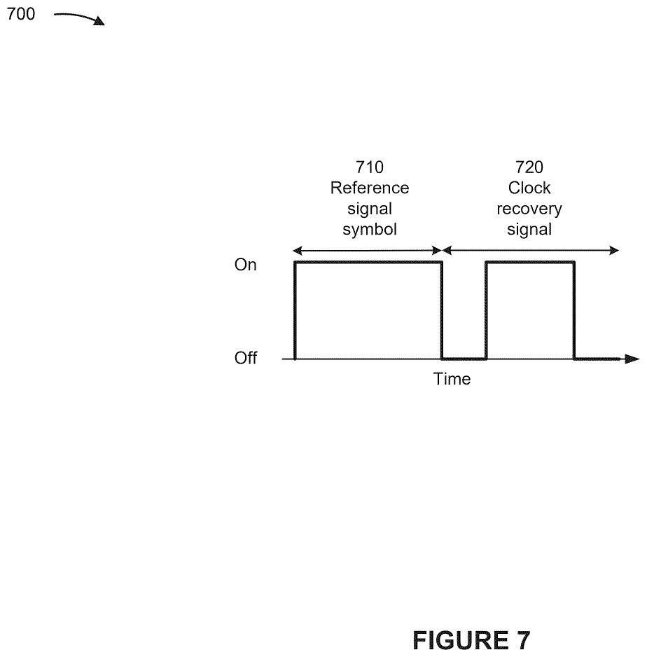

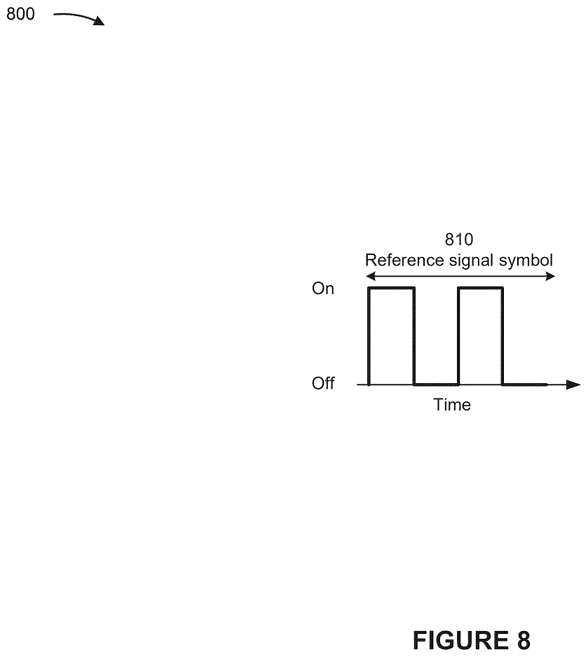

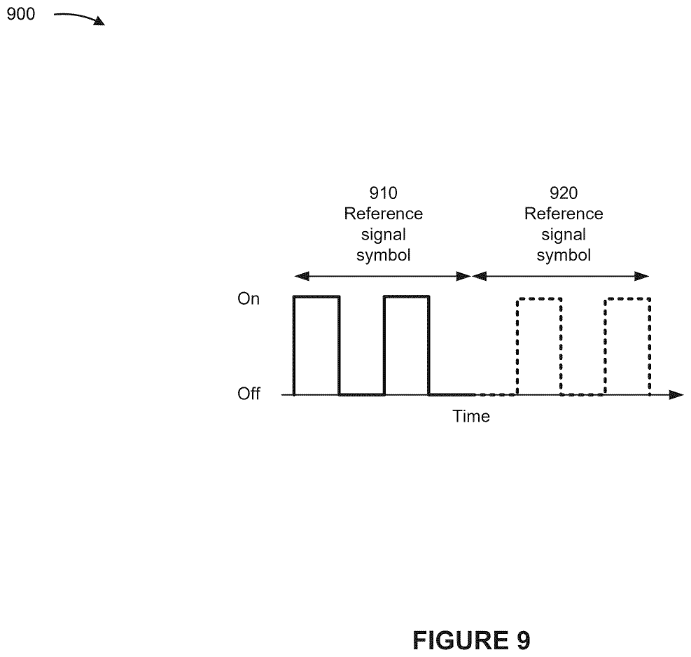

In a first operation 620, the network node 110 may transmit, and the UE 120 may receive, a configuration associated with multiplexing of ambient IoT waveforms and UE reference signals. The configuration may be associated with multiplexing of ambient IoT waveforms and UE reference signals in that the configuration may indicate an implementation for multiplexing ambient IoT waveforms and UE reference signals. For example, the configuration may indicate a first implementation for multiplexing ambient IoT waveforms and UE reference signals (as discussed in connection with FIG. 7 below), a second implementation for multiplexing ambient IoT waveforms and UE reference signals (as discussed in connection with FIG. 8 below), or a third implementation for multiplexing ambient IoT waveforms and UE reference signals (as discussed in connection with FIG. 9 below). The configuration may be carried via RRC signaling, MAC-CE, or DCI, among other examples.

In a second operation 630, the network node 110 may transmit, and the ambient IoT device 610 may receive, one or more ambient IoT control channel communications associated with multiplexing of ambient IoT waveforms and UE reference signals. The one or more ambient IoT control channel communications may be associated with multiplexing of ambient IoT waveforms and UE reference signals in that the one or more ambient IoT control channel communications may indicate an implementation for multiplexing ambient IoT waveforms and UE reference signals. For example, the one or more ambient IoT control channel communications may indicate the first implementation for multiplexing ambient IoT waveforms and UE reference signals, the second implementation for multiplexing ambient IoT waveforms and UE reference signals, or the third implementation for multiplexing ambient IoT waveforms and UE reference signals. In some examples, the one or more ambient IoT control channel communications may include one or more communications that are carried over an ambient IoT control channel, such as a physical reader to device channel (PRDCH).

In a third operation 640, the network node 110 may transmit, and the UE 120 and the ambient IoT device 610 may receive, an ambient IoT waveform multiplexed with a UE reference signal. In some examples, the network node 110 may transmit the ambient IoT waveform multiplexed with the UE reference signal in accordance with the one or more ambient IoT control channel communications and the configuration. For example, the network node 110 may transmit the ambient IoT waveform multiplexed with the UE reference signal in accordance with the first, second, or third implementation as indicated by the one or more ambient IoT control channel communications and the configuration.

In some examples, the UE reference signal may be a downlink reference signal as discussed above in connection with FIG. 1. In some examples, the UE reference signal may have an on duration length that is equal to an entirety of an OFDM symbol. In some aspects, the UE reference signal may be a DMRS.

In some aspects, the network node 110 may transmit, and the UE 120 and the ambient IoT device 610 may receive, the ambient IoT waveform multiplexed with the UE reference signal in a reference signal symbol. The reference signal symbol may be a symbol allocated for carrying the UE reference signal. In some examples, the reference signal symbol may be a DMRS symbol. In some examples, the reference signal symbol may be an OFDM symbol.

In some aspects, a timing location of the reference signal symbol may be associated with an ambient IoT packet transmission. The timing location of the reference signal symbol may be associated with the ambient IoT packet transmission in that the timing location of the reference signal symbol may be fixed for an entirety of the ambient IoT packet transmission. “Ambient IoT packet transmission” may refer to a transmission of an ambient IoT packet that includes the ambient IoT waveform. In some examples, the network node 110 may dynamically set the timing location of the reference signal symbol (for example, a timing location of the UE reference signal) for each transmission (for example, for each ambient IoT packet transmission) by the network node 110.

In a fourth operation 650, the UE 120 may decode the UE reference signal in accordance with the configuration. For example, the UE 120 may decode the UE reference signal in accordance with the first, second, or third implementation as indicated by the configuration.

In a fifth operation 660, the ambient IoT device 610 may selectively decode the ambient IoT waveform in accordance with the one or more ambient IoT control channel communications. For example, the ambient IoT device 610 may decode, or skip decoding of, the ambient IoT waveform. In some examples, the ambient IoT device 610 may selectively decode the ambient IoT waveform in accordance with the first, second, or third implementation as indicated by the one or more ambient IoT control channel communications.

FIG. 7 is a diagram illustrating an example 700 associated with a first implementation for multiplexing ambient IoT waveforms and UE reference signals, in accordance with the present disclosure.

In some aspects, the ambient IoT waveform may include an on state for an entirety of the reference signal symbol and carry no ambient IoT information. For instance, example 700 shows an ambient IoT waveform that includes a reference signal symbol 710 (for example, a DMRS symbol and/or an OFDM symbol, among other examples). The ambient IoT information may be information (for example, OOK information) that can be decoded by the ambient IoT device 610. In some examples, the ambient IoT information may not be transmitted during the reference signal symbol 710 because Manchester coding, which may be used to encode ambient IoT information, may be incompatible with the on state persisting for the entirety of the reference signal symbol 710.

In some aspects, the ambient IoT device 610 may discard the reference signal symbol in accordance with the one or more ambient IoT control channel communications. For example, the ambient IoT device 610 may skip decoding of the ambient IoT waveform in accordance with the first implementation as indicated by the one or more ambient IoT control channel communications. For example, the ambient IoT device 610 may discard the reference signal symbol during a data detection operation.

In some aspects, the network node 110 may transmit, and the ambient IoT device 610 may receive, a clock recovery signal. For instance, example 700 shows a clock recovery signal 720. In some examples, the network node 110 may transmit the clock recovery signal after transmitting the ambient IoT waveform, and the ambient IoT device 610 may receive the clock recovery signal after receiving the ambient IoT waveform. For example, the clock recovery signal 720 may follow the reference signal symbol 710. In some examples, the clock recovery signal 720 may be a midamble that is included after the reference signal symbol 710. In example 700, the clock recovery signal 720 includes a sequence of 0110.

In some aspects, the one or more ambient IoT control channel communications may include an indication of a timing location of the reference signal symbol (for example, the reference signal symbol 710). For example, the ambient IoT device 610 may decode the timing location of the reference signal symbol using the ambient IoT control channel.

In some aspects, the one or more ambient IoT control channel communications may include information associated with the clock recovery signal (for example, the clock recovery signal 720). The information may be associated with the clock recovery signal in that the information may indicate a sequence of the clock recovery signal.

FIG. 8 is a diagram illustrating an example 800 associated with a second implementation for multiplexing ambient IoT waveforms and UE reference signals, in accordance with the present disclosure.

In some aspects, the ambient IoT waveform may include an on state and an off state during the reference signal symbol, and carries ambient IoT information. For instance, example 800 shows an ambient IoT waveform that includes a reference signal symbol 810 (for example, a DMRS symbol and/or an OFDM symbol, among other examples). In some examples, the ambient IoT information may be transmitted during the reference signal symbol 810 because Manchester coding, which may be used to encode ambient IoT information, may be compatible with the reference signal symbol 810 including both on and off states.

In some aspects, the ambient IoT device 610 may decode the ambient IoT waveform in accordance with the ambient IoT control channel communication. For example, the ambient IoT device 610 may decode the ambient IoT waveform in accordance with the second implementation as indicated by the one or more ambient IoT control channel communications.

In some aspects, the ambient IoT waveform may include an OOK waveform. For example, the reference signal symbol 810 may include an OOK waveform pattern (for example, an OOK data pattern).

In some aspects, the UE 120 may decode the UE reference signal in accordance with one or more timing locations associated with the on state and the off state. The one or more timing locations may be associated with the on state and the off state in that the one or more timing locations may indicate a timing location of the on state and a timing location of the off state. For example, the UE 120 may decode and/or estimate the ambient IoT waveform during the reference signal symbol 810 and identify the locations of the ‘1’ bits. The locations of the ‘1’ bits may change depending on the data that is to be transmitted to the ambient IoT device 610. For instance, in example 800, the ambient IoT waveform includes a bit pattern of ‘1010.’ In other examples, the ambient IoT waveform may include other bit patterns, such as ‘0101’ or ‘0110,’ among other examples. After decoding the ambient IoT waveform and identifying the locations of the ‘1’ bits, the UE 120 may generate a frequency-domain-transmitted UE reference signal by applying a DFT on the estimated ambient IoT waveform and known data in a pre-DFT domain. If the UE reference signal is a DMRS, then the UE 120 may perform channel estimation using the frequency-domain-transmitted DMRS.

FIG. 9 is a diagram illustrating an example 900 associated with a third implementation for multiplexing ambient IoT waveforms and UE reference signals, in accordance with the present disclosure.

In some aspects, the network node 110 may transmit, and the ambient IoT device may receive, in another reference signal symbol, another ambient IoT waveform multiplexed with the UE reference signal. For instance, example 900 shows an ambient IoT waveform that includes a reference signal symbol 910 (for example, a DMRS symbol and/or an OFDM symbol, among other examples) and another reference signal symbol 920. Both the reference signal symbol 910 and the other reference signal symbol 920 may be multiplexed with the UE reference signal. For example, the UE reference signal may be transmitted across two OFDM symbols. The reference signal symbol 910 may follow the ambient IoT waveform pattern. In some examples, OOK data in the reference signal symbol 910 may be random (for example, arbitrary, depending on the data to be transmitted to the ambient IoT device 610). For instance, in example 900, the reference signal symbol 910 includes a data pattern of ‘1010.’

In some aspects, the other ambient IoT waveform may be an opposite-state waveform relative to the ambient IoT waveform, and carries the ambient IoT information. The other ambient IoT waveform may be an opposite-state waveform relative to the ambient IoT waveform in that the other ambient IoT waveform may include a bit pattern that is reversed, as compared to the bit pattern of the ambient IoT waveform. For instance, example 900 shows another reference signal symbol 920 that follows the ambient IoT waveform pattern and includes a data pattern of ‘0101.’ Thus, the data pattern may not be random and may instead carry an opposite bit pattern relative to the reference signal symbol 910.

In some aspects, the one or more ambient IoT control channel communications may include an indication of a timing location of the other reference signal symbol (for example, the other reference signal symbol 920). For example, the ambient IoT device 610 may decode the timing location of the other reference signal symbol using the ambient IoT control channel.

In some aspects, the ambient IoT device 610 may decode the other ambient IoT waveform. For example, the ambient IoT device 610 may decode the other ambient IoT waveform in accordance with the third implementation as indicated by the one or more ambient IoT control channel communications. For example, the ambient IoT device 610 may decode the timing location of the other reference signal symbol using the ambient IoT control channel, and jointly decode the received signal of the other reference signal symbol with the reference signal symbol.

In some aspects, the ambient IoT device 610 may discard the other reference signal symbol. For example, the ambient IoT device 610 may skip decoding of the other ambient IoT waveform in accordance with the third implementation as indicated by the one or more ambient IoT control channel communications. For example, the ambient IoT device 610 may decode the timing location of the other reference signal symbol using the ambient IoT control channel and discard the other reference signal symbol.

In some aspects, the UE 120 may decode the UE reference signal in accordance with one or more timing locations associated with the on state and the off state during the reference signal symbol and one or more other timing locations associated with an on state and an off state during the other reference signal symbol. The one or more timing locations may be associated with the on state and the off state during the reference signal symbol in that the one or more timing locations may indicate a timing location of the on state during the reference signal symbol and a timing location of the off state during the reference signal symbol. The one or more timing locations may be associated with the on state and the off state during the other reference signal symbol in that the one or more timing locations may indicate a timing location of the on state during the other reference signal symbol and a timing location of the off state during the other reference signal symbol. If the UE reference signal is a DMRS, then the UE 120 may perform channel estimation by combining time-domain-received signals across the reference signal symbols 910 and 920.

The ambient IoT waveform multiplexed with the UE reference signal may enable the network node 110 to serve the ambient IoT device 610 and the UE 120 during the same time period. For example, the network node 110 may use the same time and/or frequency resources to carry a communication to the ambient IoT device 610 (for ambient, the ambient IoT waveform) and a UE reference signal to the UE 120.

The ambient IoT waveform comprising an on state for an entirety of the reference signal symbol and carrying no ambient IoT information may enable the UE 120 to process the UE reference signal without additional complexity.

Discarding the reference signal symbol in accordance with the one or more ambient IoT control channel communications may help to conserve ambient IoT processing resources by allowing the ambient IoT device 610 to skip decoding of the reference signal symbol.

Receiving the clock recovery signal after receiving the ambient IoT waveform may enable the ambient IoT device 610 to recover a clock synchronization using correlations associated with the clock recovery signal after a transmission of continuous 1-bits in the reference signal symbol.

The one or more ambient IoT control channel communications including an indication of a timing location of the reference signal symbol may allow the ambient IoT device 610 to identify the timing location of the reference signal symbol and thereby skip data detection during the reference signal symbol.

The ambient IoT waveform comprising an on state and an off state during the reference signal symbol and carrying ambient IoT information may conserve time and/or frequency resources by skipping transmission of the clock recovery signal. For example, the UE reference signal may align with Manchester coding, allowing ambient IoT data to be transmitted in the reference signal symbol with no rate loss for the ambient IoT device 610. Additionally or alternatively, the ambient IoT device 610 may skip processing of a reference signal configuration because the UE reference signal may be transparent to the ambient IoT device 610.

Receiving the other ambient IoT waveform multiplexed with the UE reference signal in the other reference signal symbol may help to improve UE reference signal transmission and/or reduce a quantity of retransmissions of the UE reference signal. For example, if the UE reference signal is a DMRS, then the channel estimation accuracy for certain subcarriers may improve. For example, the UE 120 may account for a frequency-domain-transmitted DMRS varying across frequencies, such as at the edges of the frequency range, due to an OOK pattern in the pre-DFT domain.

The one or more ambient IoT control channel communications including an indication of a timing location of the other reference signal symbol may enable the ambient IoT device 610 to identify the timing location of the other reference signal symbol and thereby skip data detection during the other reference signal symbol.

Decoding the other ambient IoT waveform may enable the ambient IoT device 610 to obtain an additional processing gain for bits transmitted on the reference signal symbol.

Decoding the UE reference signal in accordance with one or more timing locations associated with the on state and the off state during the reference signal symbol and one or more timing locations associated with an on state and an off state during the other reference signal symbol may enable the UE 120 to process the UE reference signal (for example, to estimate a channel if the UE reference signal is a DMRS) with minimal or no efficiency loss.

FIG. 10 is a flowchart illustrating an example process 1000 performed, for example, at an ambient IoT device or an apparatus of an ambient IoT device that supports multiplexing of ambient IoT waveforms and UE reference signals in accordance with the present disclosure. Example process 1000 is an example where the apparatus or the ambient IoT device (for example, ambient IoT device 610) performs operations associated with multiplexing of ambient IoT waveforms and UE reference signals.

As shown in FIG. 10, in some aspects, process 1000 may include receiving one or more ambient IoT control channel communications associated with multiplexing of ambient IoT waveforms and UE reference signals (block 1010). For example, the ambient IoT device (such as by using communication manager 150d or 150e or reception component 1302, depicted in FIG. 1312) may receive one or more ambient IoT control channel communications associated with multiplexing of ambient IoT waveforms and UE reference signals, as described above.

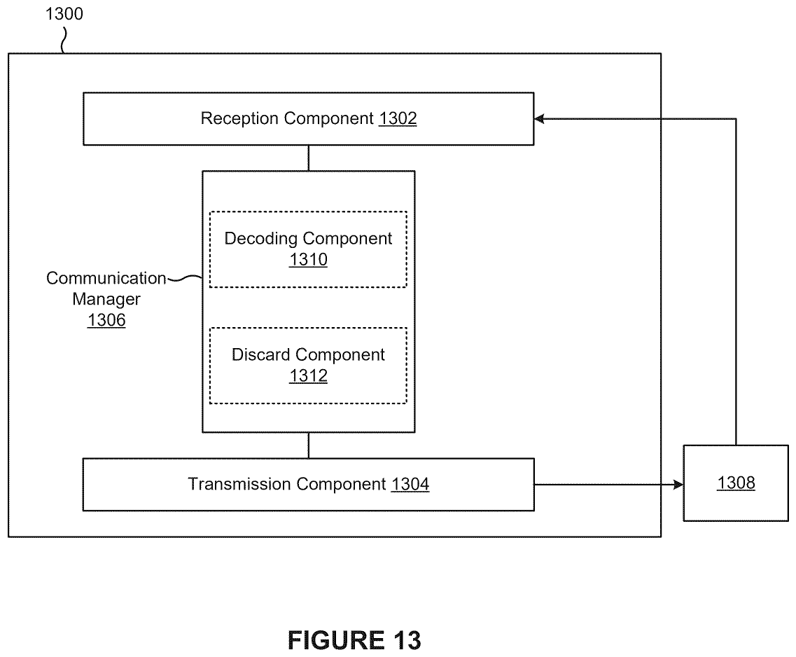

As further shown in FIG. 10, in some aspects, process 1000 may include receiving, in a reference signal symbol, an ambient IoT waveform multiplexed with a UE reference signal (block 1020). For example, the ambient IoT device (such as by using communication manager 150d or 150e or reception component 1302, depicted in FIG. 13) may receive, in a reference signal symbol, an ambient IoT waveform multiplexed with a UE reference signal, as described above.

As further shown in FIG. 10, in some aspects, process 1000 may include selectively decoding the ambient IoT waveform in accordance with the one or more ambient IoT control channel communications (block 1030). For example, the ambient IoT device (such as by using communication manager 150d or 150e or decoding component 1310, depicted in FIG. 13) may selectively decode the ambient IoT waveform in accordance with the one or more ambient IoT control channel communications, as described above.

Process 1000 may include additional aspects, such as any single aspect or any combination of aspects described below or in connection with one or more other processes described elsewhere herein.

In a first additional aspect, the ambient IoT waveform comprises an on state for an entirety of the reference signal symbol and carries no ambient IoT information.

In a second additional aspect, alone or in combination with the first aspect, selectively decoding the ambient IoT waveform includes discarding the reference signal symbol in accordance with the one or more ambient IoT control channel communications.

In a third additional aspect, alone or in combination with one or more of the first and second aspects, process 1000 includes receiving a clock recovery signal after receiving the ambient IoT waveform.

In a fourth additional aspect, alone or in combination with one or more of the first through third aspects, the one or more ambient IoT control channel communications include an indication of a timing location of the reference signal symbol.

In a fifth additional aspect, alone or in combination with one or more of the first through fourth aspects, the one or more ambient IoT control channel communications include information associated with a clock recovery signal.

In a sixth additional aspect, alone or in combination with one or more of the first through fifth aspects, the ambient IoT waveform comprises an on state and an off state during the reference signal symbol and carries ambient IoT information.

In a seventh additional aspect, alone or in combination with one or more of the first through sixth aspects, selectively decoding the ambient IoT waveform includes decoding the ambient IoT waveform in accordance with the one or more ambient IoT control channel communications.

In an eighth additional aspect, alone or in combination with one or more of the first through seventh aspects, the ambient IoT waveform comprises an OOK waveform.

In a ninth additional aspect, alone or in combination with one or more of the first through eighth aspects, the reference signal symbol is a first reference signal symbol, the ambient IoT waveform is a first ambient IoT waveform, and process 1000 includes receiving, in a second reference signal symbol, a second ambient IoT waveform multiplexed with the UE reference signal.

In a tenth additional aspect, alone or in combination with one or more of the first through ninth aspects, the second ambient IoT waveform comprises an opposite-state waveform relative to the first ambient IoT waveform and carries the ambient IoT information.

In an eleventh additional aspect, alone or in combination with one or more of the first through tenth aspects, the one or more ambient IoT control channel communications include an indication of a timing location of the second reference signal symbol.

In a twelfth additional aspect, alone or in combination with one or more of the first through eleventh aspects, process 1000 includes decoding the second ambient IoT waveform.

In a thirteenth additional aspect, alone or in combination with one or more of the first through twelfth aspects, process 1000 includes discarding the second reference signal symbol.

In a fourteenth additional aspect, alone or in combination with one or more of the first through thirteenth aspects, a timing location of the reference signal symbol is associated with an ambient IoT packet transmission.

In a fifteenth additional aspect, alone or in combination with one or more of the first through fourteenth aspects, the UE reference signal comprises a DMRS.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a UE or an apparatus of a UE that supports multiplexing of ambient IoT waveforms and UE reference signals in accordance with the present disclosure. Example process 1100 is an example where the apparatus or the UE (for example, UE 120) performs operations associated with multiplexing of ambient IoT waveforms and UE reference signals.

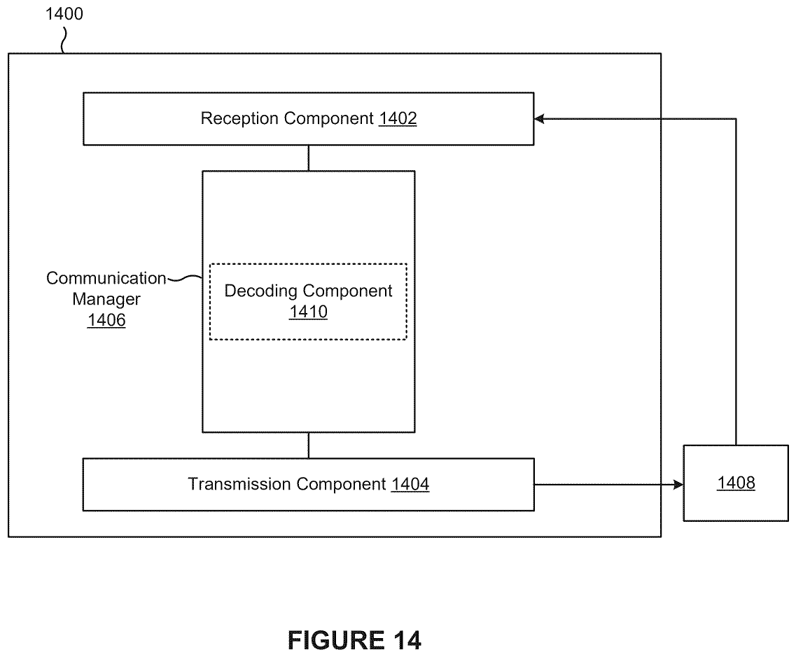

As shown in FIG. 11, in some aspects, process 1100 may include receiving a configuration associated with multiplexing of ambient IoT waveforms and UE reference signals (block 1110). For example, the UE (such as by using communication manager 150 or reception component 1402, depicted in FIG. 14) may receive a configuration associated with multiplexing of ambient IoT waveforms and UE reference signals, as described above.

As further shown in FIG. 11, in some aspects, process 1100 may include receiving, in a reference signal symbol, an ambient IoT waveform multiplexed with a UE reference signal (block 1120). For example, the UE (such as by using communication manager 150 or reception component 1402, depicted in FIG. 14) may receive, in a reference signal symbol, an ambient IoT waveform multiplexed with a UE reference signal, as described above.

As further shown in FIG. 11, in some aspects, process 1100 may include decoding the UE reference signal in accordance with the configuration (block 1130). For example, the UE (such as by using communication manager 150 or decoding component 1410, depicted in FIG. 14) may decode the UE reference signal in accordance with the configuration, as described above.

Process 1100 may include additional aspects, such as any single aspect or any combination of aspects described below or in connection with one or more other processes described elsewhere herein.

In a first additional aspect, the ambient IoT waveform comprises an on state for an entirety of the reference signal symbol and carries no ambient IoT information.

In a second additional aspect, alone or in combination with the first aspect, the ambient IoT waveform comprises an on state and an off state during the reference signal symbol and carries ambient IoT information.

In a third additional aspect, alone or in combination with one or more of the first and second aspects, the ambient IoT waveform comprises an OOK waveform.

In a fourth additional aspect, alone or in combination with one or more of the first through third aspects, decoding the UE reference signal includes decoding the UE reference signal in accordance with one or more timing locations associated with the on state and the off state.

In a fifth additional aspect, alone or in combination with one or more of the first through fourth aspects, the reference signal symbol is a first reference signal symbol, the ambient IoT waveform is a first ambient IoT waveform, and process 1100 includes receiving, in a second reference signal symbol, a second ambient IoT waveform multiplexed with the UE reference signal.

In a sixth additional aspect, alone or in combination with one or more of the first through fifth aspects, the second ambient IoT waveform comprises an opposite-state waveform relative to the first ambient IoT waveform and carries the ambient IoT information.

In a seventh additional aspect, alone or in combination with one or more of the first through sixth aspects, decoding the UE reference signal includes decoding the UE reference signal in accordance with one or more first timing locations associated with the on state and the off state during the first reference signal symbol and one or more second timing locations associated with an on state and an off state during the second reference signal symbol.

In an eighth additional aspect, alone or in combination with one or more of the first through seventh aspects, a timing location of the reference signal symbol is associated with an ambient IoT packet transmission.

In a ninth additional aspect, alone or in combination with one or more of the first through eighth aspects, the UE reference signal comprises a DMRS.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, at a network node or an apparatus of a network node that supports multiplexing of ambient IoT waveforms and UE reference signals in accordance with the present disclosure. Example process 1200 is an example where the apparatus or the network node (for example, network node 110) performs operations associated with multiplexing of ambient IoT waveforms and UE reference signals.

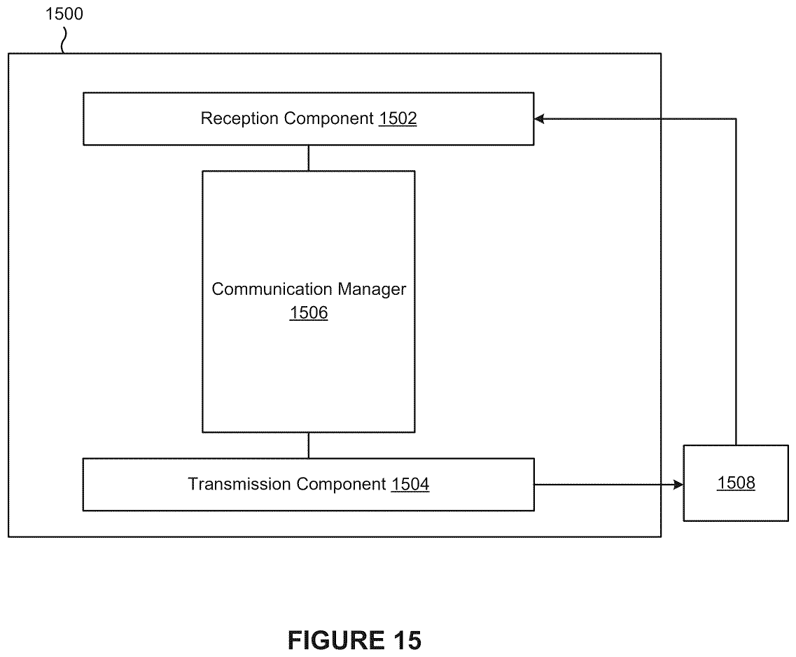

As shown in FIG. 12, in some aspects, process 1200 may include transmitting one or more ambient IoT control channel communications associated with multiplexing of ambient IoT waveforms and UE reference signals (block 1210). For example, the network node (such as by using communication manager 155 or transmission component 1504, depicted in FIG. 15) may transmit one or more ambient IoT control channel communications associated with multiplexing of ambient IoT waveforms and UE reference signals, as described above.

As further shown in FIG. 12, in some aspects, process 1200 may include transmitting a configuration associated with the multiplexing of the ambient IoT waveforms and the UE reference signals (block 1220). For example, the network node (such as by using communication manager 155 or transmission component 1504, depicted in FIG. 15) may transmit a configuration associated with the multiplexing of the ambient IoT waveforms and the UE reference signals, as described above.

As further shown in FIG. 12, in some aspects, process 1200 may include transmitting, in a reference signal symbol, an ambient IoT waveform multiplexed with a UE reference signal in accordance with the one or more ambient IoT control channel communications and the configuration (block 1230). For example, the network node (such as by using communication manager 155 or transmission component 1504, depicted in FIG. 15) may transmit, in a reference signal symbol, an ambient IoT waveform multiplexed with a UE reference signal in accordance with the one or more ambient IoT control channel communications and the configuration, as described above.

Process 1200 may include additional aspects, such as any single aspect or any combination of aspects described below or in connection with one or more other processes described elsewhere herein.

In a first additional aspect, the ambient IoT waveform comprises an on state for an entirety of the reference signal symbol and carries no ambient IoT information.

In a second additional aspect, alone or in combination with the first aspect, process 1200 includes transmitting a clock recovery signal after transmitting the ambient IoT waveform.

In a third additional aspect, alone or in combination with one or more of the first and second aspects, the one or more ambient IoT control channel communications include an indication of a timing location of the reference signal symbol.

In a fourth additional aspect, alone or in combination with one or more of the first through third aspects, the one or more ambient IoT control channel communications include information associated with a clock recovery signal.

In a fifth additional aspect, alone or in combination with one or more of the first through fourth aspects, the ambient IoT waveform comprises an on state and an off state during the reference signal symbol and carries ambient IoT information.

In a sixth additional aspect, alone or in combination with one or more of the first through fifth aspects, the ambient IoT waveform comprises an OOK waveform.

In a seventh additional aspect, alone or in combination with one or more of the first through sixth aspects, the reference signal symbol is a first reference signal symbol, the ambient IoT waveform is a first ambient IoT waveform, and process 1200 includes transmitting, in a second reference signal symbol, a second ambient IoT waveform multiplexed with the UE reference signal.

In an eighth additional aspect, alone or in combination with one or more of the first through seventh aspects, the second ambient IoT waveform comprises an opposite-state waveform relative to the first ambient IoT waveform and carries the ambient IoT information.

In a ninth additional aspect, alone or in combination with one or more of the first through eighth aspects, the one or more ambient IoT control channel communications include an indication of a timing location of the second reference signal symbol.

In a tenth additional aspect, alone or in combination with one or more of the first through ninth aspects, a timing location of the reference signal symbol is associated with an ambient IoT packet transmission.

In an eleventh additional aspect, alone or in combination with one or more of the first through tenth aspects, the UE reference signal comprises a DMRS.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication that supports multiplexing of ambient IoT waveforms and UE reference signals in accordance with the present disclosure. The apparatus 1300 may be an ambient IoT device, or an ambient IoT device may include the apparatus 1300. In some aspects, the apparatus 1300 includes a reception component 1302, a transmission component 1304, and a communication manager 1306, which may be in communication with one another (for example, via one or more buses). As shown, the apparatus 1300 may communicate with another apparatus 1308 (such as a UE 120, a network node 110, or another wireless communication device) using the reception component 1302 and the transmission component 1304. The communication manager 1306 may be included in, or implemented via, a processing system (for example, the processing system 140d or 140e). In some aspects, the communication manager 1306 is the communication manager 150d or 150e.

In some aspects, the apparatus 1300 may be configured to and/or operable to perform one or more operations described herein in connection with FIGS. 6-9. Additionally or alternatively, the apparatus 1300 may be configured to and/or operable to perform one or more processes described herein, such as process 1000 of FIG. 10.

The reception component 1302 may receive communications, such as reference signals, control information, and/or data communications, from the apparatus 1308. The reception component 1302 may provide received communications to one or more other components of the apparatus 1300, such as the communication manager 1306. In some aspects, the reception component 1302 may perform signal processing on the received communications, and may provide the processed signals to the one or more other components in a similar manner as described above in connection with FIG. 1. In some aspects, the reception component 1302 may include one or more components of the ambient IoT device described above in connection with FIG. 1, such as a radio, one or more RF chains, one or more transceivers, or one or more modems, each of which may in turn be coupled with one or more antennas of the ambient IoT device.

The transmission component 1304 may transmit communications, such as reference signals, control information, and/or data communications, to the apparatus 1308. In some aspects, the communication manager 1306 may generate communications and may transmit the generated communications to the transmission component 1304 for transmission to the apparatus 1308. In some aspects, the transmission component 1304 may perform signal processing on the generated communications, and may transmit the processed signals to the apparatus 1308 in a similar manner as described above in connection with FIG. 1. In some aspects, the transmission component 1304 may include one or more components of the ambient IoT device described above in connection with FIG. 1, such as a radio, one or more RF chains, one or more transceivers, or one or more modems, each of which may in turn be coupled with one or more antennas of the ambient IoT device. In some aspects, the transmission component 1304 may be co-located with the reception component 1302.

The communication manager 1306 may receive or may cause the reception component 1302 to receive one or more ambient IoT control channel communications associated with multiplexing of ambient IoT waveforms and UE reference signals. The communication manager 1306 may receive or may cause the reception component 1302 to receive, in a reference signal symbol, an ambient IoT waveform multiplexed with a UE reference signal. The communication manager 1306 may selectively decode the ambient IoT waveform in accordance with the one or more ambient IoT control channel communications. In some aspects, the communication manager 1306 may perform one or more operations described elsewhere herein as being performed by one or more components of the communication manager 1306.

In some aspects, the communication manager 1306 includes a set of components, such as a decoding component 1310. Alternatively, the set of components may be separate and distinct from the communication manager 1306. As used herein, the term “component” is intended to be broadly construed as hardware or a combination of hardware and at least one of software or firmware. In some aspects, one or more components of the set of components may include or may be implemented within a processing system (for example, the processing system 140d or 140e). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1302 may receive one or more ambient IoT control channel communications associated with multiplexing of ambient IoT waveforms and UE reference signals. The reception component 1302 may receive, in a reference signal symbol, an ambient IoT waveform multiplexed with a UE reference signal. The decoding component 1310 may selectively decode the ambient IoT waveform in accordance with the one or more ambient IoT control channel communications. In some aspects, the reception component 1302 may receive a clock recovery signal after receiving the ambient IoT waveform. In some aspects, the decoding component 1310 may decode the second ambient IoT waveform. In some aspects, the discard component 1312 may discard the second reference signal symbol.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports multiplexing of ambient IoT waveforms and UE reference signals in accordance with the present disclosure. The apparatus 1400 may be a UE, or a UE may include the apparatus 1400. In some aspects, the apparatus 1400 includes a reception component 1402, a transmission component 1404, and a communication manager 1406, which may be in communication with one another (for example, via one or more buses). As shown, the apparatus 1400 may communicate with another apparatus 1408 (such as a UE 120, a network node 110, or another wireless communication device) using the reception component 1402 and the transmission component 1404. The communication manager 1406 may be included in, or implemented via, a processing system (for example, the processing system 140). In some aspects, the communication manager 1406 is the communication manager 150.

In some aspects, the apparatus 1400 may be configured to and/or operable to perform one or more operations described herein in connection with FIGS. 6-9. Additionally or alternatively, the apparatus 1400 may be configured to and/or operable to perform one or more processes described herein, such as process 1100 of FIG. 11.

The reception component 1402 may receive communications, such as reference signals, control information, and/or data communications, from the apparatus 1408. The reception component 1402 may provide received communications to one or more other components of the apparatus 1400, such as the communication manager 1406. In some aspects, the reception component 1402 may perform signal processing on the received communications, and may provide the processed signals to the one or more other components in a similar manner as described above in connection with FIG. 1. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, and/or data communications, to the apparatus 1408. In some aspects, the communication manager 1406 may generate communications and may transmit the generated communications to the transmission component 1404 for transmission to the apparatus 1408. In some aspects, the transmission component 1404 may perform signal processing on the generated communications, and may transmit the processed signals to the apparatus 1408 in a similar manner as described above in connection with FIG. 1. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE. In some aspects, the transmission component 1404 may be co-located with the reception component 1402.

The communication manager 1406 may receive or may cause the reception component 1402 to receive a configuration associated with multiplexing of ambient IoT waveforms and UE reference signals. The communication manager 1406 may receive or may cause the reception component 1402 to receive, in a reference signal symbol, an ambient IoT waveform multiplexed with a UE reference signal. The communication manager 1406 may decode the UE reference signal in accordance with the configuration. In some aspects, the communication manager 1406 may perform one or more operations described elsewhere herein as being performed by one or more components of the communication manager 1406.

In some aspects, the communication manager 1406 includes a set of components, such as a decoding component 1410. Alternatively, the set of components may be separate and distinct from the communication manager 1406. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1402 may receive a configuration associated with multiplexing of ambient IoT waveforms and UE reference signals. The reception component 1402 may receive, in a reference signal symbol, an ambient IoT waveform multiplexed with a UE reference signal. The decoding component 1410 may decode the UE reference signal in accordance with the configuration.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

FIG. 15 is a diagram of an example apparatus 1500 for wireless communication that supports multiplexing of ambient IoT waveforms and UE reference signals in accordance with the present disclosure. The apparatus 1500 may be a network node, or a network node may include the apparatus 1500. In some aspects, the apparatus 1500 includes a reception component 1502, a transmission component 1504, and a communication manager 1506, which may be in communication with one another (for example, via one or more buses). As shown, the apparatus 1500 may communicate with another apparatus 1508 (such as a UE 120, a network node 110, or another wireless communication device) using the reception component 1502 and the transmission component 1504. The communication manager 1506 may be included in, or implemented via, a processing system (for example, the processing system 145). In some aspects, the communication manager 1506 is the communication manager 155.

In some aspects, the apparatus 1500 may be configured to and/or operable to perform one or more operations described herein in connection with FIGS. 6-9. Additionally or alternatively, the apparatus 1500 may be configured to and/or operable to perform one or more processes described herein, such as process 1200 of FIG. 12.

The reception component 1502 may receive communications, such as reference signals, control information, and/or data communications, from the apparatus 1508. The reception component 1502 may provide received communications to one or more other components of the apparatus 1500, such as the communication manager 1506. In some aspects, the reception component 1502 may perform signal processing on the received communications, and may provide the processed signals to the one or more other components in a similar manner as described above in connection with FIG. 1. In some aspects, the reception component 1502 may include one or more components of the network node described above in connection with FIG. 1, such as a radio, one or more RF chains, one or more transceivers, or one or more modems, each of which may in turn be coupled with one or more antennas of the network node.

The transmission component 1504 may transmit communications, such as reference signals, control information, and/or data communications, to the apparatus 1508. In some aspects, the communication manager 1506 may generate communications and may transmit the generated communications to the transmission component 1504 for transmission to the apparatus 1508. In some aspects, the transmission component 1504 may perform signal processing on the generated communications, and may transmit the processed signals to the apparatus 1508 in a similar manner as described above in connection with FIG. 1. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node. In some aspects, the transmission component 1504 may be co-located with the reception component 1502.

The communication manager 1506 may transmit or may cause the transmission component 1504 to transmit one or more ambient IoT control channel communications associated with multiplexing of ambient IoT waveforms and UE reference signals. The communication manager 1506 may transmit or may cause the transmission component 1504 to transmit a configuration associated with the multiplexing of the ambient IoT waveforms and the UE reference signals. The communication manager 1506 may transmit or may cause the transmission component 1504 to transmit, in a reference signal symbol, an ambient IoT waveform multiplexed with a UE reference signal in accordance with the one or more ambient IoT control channel communications and the configuration. In some aspects, the communication manager 1506 may perform one or more operations described elsewhere herein as being performed by one or more components of the communication manager 1506.

The transmission component 1504 may transmit one or more ambient IoT control channel communications associated with multiplexing of ambient IoT waveforms and UE reference signals. The transmission component 1504 may transmit a configuration associated with the multiplexing of the ambient IoT waveforms and the UE reference signals. The transmission component 1504 may transmit, in a reference signal symbol, an ambient IoT waveform multiplexed with a UE reference signal in accordance with the one or more ambient IoT control channel communications and the configuration. In some aspects, the transmission component 1504 may transmit a clock recovery signal after transmitting the ambient IoT waveform.

The quantity and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed at an ambient internet of things (IoT) device, comprising: receiving one or more ambient IoT control channel communications associated with multiplexing of ambient IoT waveforms and user equipment (UE) reference signals; receiving, in a reference signal symbol, an ambient IoT waveform multiplexed with a UE reference signal; and selectively decoding the ambient IoT waveform in accordance with the one or more ambient IoT control channel communications.

Aspect 2: The method of Aspect 1, wherein the ambient IoT waveform comprises an on state for an entirety of the reference signal symbol and carries no ambient IoT information.

Aspect 3: The method of Aspect 2, wherein selectively decoding the ambient IoT waveform includes discarding the reference signal symbol in accordance with the one or more ambient IoT control channel communications.

Aspect 4: The method of Aspect 2, further comprising: receiving a clock recovery signal after receiving the ambient IoT waveform.

Aspect 5: The method of Aspect 2, wherein the one or more ambient IoT control channel communications include an indication of a timing location of the reference signal symbol.

Aspect 6: The method of Aspect 2, wherein the one or more ambient IoT control channel communications include information associated with a clock recovery signal.

Aspect 7: The method of any of Aspects 1-6, wherein the ambient IoT waveform comprises an on state and an off state during the reference signal symbol and carries ambient IoT information.

Aspect 8: The method of Aspect 7, wherein selectively decoding the ambient IoT waveform includes decoding the ambient IoT waveform in accordance with the one or more ambient IoT control channel communications.

Aspect 9: The method of Aspect 7, wherein the ambient IoT waveform comprises an on-off keying (OOK) waveform.

Aspect 10: The method of Aspect 7, wherein the reference signal symbol is a first reference signal symbol, and the ambient IoT waveform is a first ambient IoT waveform, the method further comprising: receiving, in a second reference signal symbol, a second ambient IoT waveform multiplexed with the UE reference signal.

Aspect 11: The method of Aspect 10, wherein the second ambient IoT waveform comprises an opposite-state waveform relative to the first ambient IoT waveform and carries the ambient IoT information.

Aspect 12: The method of Aspect 10, wherein the one or more ambient IoT control channel communications include an indication of a timing location of the second reference signal symbol.

Aspect 13: The method of Aspect 10, further comprising: decoding the second ambient IoT waveform.

Aspect 14: The method of Aspect 10, further comprising: discarding the second reference signal symbol.

Aspect 15: The method of any of Aspects 1-14, wherein a timing location of the reference signal symbol is associated with an ambient IoT packet transmission.

Aspect 16: The method of any of Aspects 1-15, wherein the UE reference signal comprises a demodulation reference signal (DMRS).

Aspect 17: A method of wireless communication performed at a user equipment (UE), comprising: receiving a configuration associated with multiplexing of ambient internet of things (IoT) waveforms and UE reference signals; receiving, in a reference signal symbol, an ambient IoT waveform multiplexed with a UE reference signal; and decoding the UE reference signal in accordance with the configuration.

Aspect 18: The method of Aspect 17, wherein the ambient IoT waveform comprises an on state for an entirety of the reference signal symbol and carries no ambient IoT information.

Aspect 19: The method of any of Aspects 17-18, wherein the ambient IoT waveform comprises an on state and an off state during the reference signal symbol and carries ambient IoT information.

Aspect 20: The method of Aspect 19, wherein the ambient IoT waveform comprises an on-off keying (OOK) waveform.

Aspect 21: The method of Aspect 19, wherein decoding the UE reference signal includes decoding the UE reference signal in accordance with one or more timing locations associated with the on state and the off state.

Aspect 22: The method of Aspect 19, wherein the reference signal symbol is a first reference signal symbol, and the ambient IoT waveform is a first ambient IoT waveform, the method further comprising: receiving, in a second reference signal symbol, a second ambient IoT waveform multiplexed with the UE reference signal.

Aspect 23: The method of Aspect 22, wherein the second ambient IoT waveform comprises an opposite-state waveform relative to the first ambient IoT waveform and carries the ambient IoT information.

Aspect 24: The method of Aspect 22, wherein decoding the UE reference signal includes decoding the UE reference signal in accordance with one or more first timing locations associated with the on state and the off state during the first reference signal symbol and one or more second timing locations associated with an on state and an off state during the second reference signal symbol.

Aspect 25: The method of any of Aspects 17-24, wherein a timing location of the reference signal symbol is associated with an ambient IoT packet transmission.

Aspect 26: The method of any of Aspects 17-25, wherein the UE reference signal comprises a demodulation reference signal (DMRS).

Aspect 27: A method of wireless communication performed at a network node, comprising: transmitting one or more ambient internet of things (IoT) control channel communications associated with multiplexing of ambient IoT waveforms and user equipment (UE) reference signals; transmitting a configuration associated with the multiplexing of the ambient IoT waveforms and the UE reference signals; and transmitting, in a reference signal symbol, an ambient IoT waveform multiplexed with a UE reference signal in accordance with the one or more ambient IoT control channel communications and the configuration.

Aspect 28: The method of Aspect 27, wherein the ambient IoT waveform comprises an on state for an entirety of the reference signal symbol and carries no ambient IoT information.

Aspect 29: The method of Aspect 28, further comprising: transmitting a clock recovery signal after transmitting the ambient IoT waveform.

Aspect 30: The method of Aspect 28, wherein the one or more ambient IoT control channel communications include an indication of a timing location of the reference signal symbol.

Aspect 31: The method of Aspect 28, wherein the one or more ambient IoT control channel communications include information associated with a clock recovery signal.

Aspect 32: The method of any of Aspects 27-31, wherein the ambient IoT waveform comprises an on state and an off state during the reference signal symbol and carries ambient IoT information.

Aspect 33: The method of Aspect 32, wherein the ambient IoT waveform comprises an on-off keying (OOK) waveform.

Aspect 34: The method of Aspect 32,wherein the reference signal symbol is a first reference signal symbol, and the ambient IoT waveform is a first ambient IoT waveform, the method further comprising: transmitting, in a second reference signal symbol, a second ambient IoT waveform multiplexed with the UE reference signal.

Aspect 35: The method of Aspect 34, wherein the second ambient IoT waveform comprises an opposite-state waveform relative to the first ambient IoT waveform and carries the ambient IoT information.

Aspect 36: The method of Aspect 34, wherein the one or more ambient IoT control channel communications include an indication of a timing location of the second reference signal symbol.

Aspect 37: The method of any of Aspects 27-36, wherein a timing location of the reference signal symbol is associated with an ambient IoT packet transmission.

Aspect 38: The method of any of Aspects 27-37, wherein the UE reference signal comprises a demodulation reference signal (DMRS).

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

Aspect 46: An apparatus for wireless communication at a device, the apparatus comprising one or more processors, at least one processor of the one or more processors configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at an ambient internet of things (IoT) device, comprising:
one or more processors, at least one processor of the one or more processors configured to cause the ambient IoT device to:
receive one or more ambient IoT control channel communications associated with multiplexing of ambient IoT waveforms and user equipment (UE) reference signals;
receive, in a reference signal symbol, an ambient IoT waveform multiplexed with a UE reference signal; and
selectively decode the ambient IoT waveform in accordance with the one or more ambient IoT control channel communications.

2. The apparatus of claim 1, wherein the ambient IoT waveform comprises an on state for an entirety of the reference signal symbol and carries no ambient IoT information.

3. The apparatus of claim 2, wherein the at least one processor, to cause the ambient IoT device to selectively decode the ambient IoT waveform, is configured to cause the ambient IoT device to discard the reference signal symbol in accordance with the one or more ambient IoT control channel communications.

4. The apparatus of claim 2, wherein at least one processor of the one or more processors is configured to cause the ambient IoT device to:
receive a clock recovery signal after receiving the ambient IoT waveform.

5. The apparatus of claim 2, wherein the one or more ambient IoT control channel communications include an indication of a timing location of the reference signal symbol.

6. The apparatus of claim 2, wherein the one or more ambient IoT control channel communications include information associated with a clock recovery signal.

7. The apparatus of claim 1, wherein the ambient IoT waveform comprises an on state and an off state during the reference signal symbol and carries ambient IoT information.

8. The apparatus of claim 7, wherein the at least one processor, to cause the ambient IoT device to selectively decode the ambient IoT waveform, is configured to cause the ambient IoT device to decode the ambient IoT waveform in accordance with the one or more ambient IoT control channel communications.

9. The apparatus of claim 7, wherein the reference signal symbol is a first reference signal symbol, and the ambient IoT waveform is a first ambient IoT waveform, and wherein at least one processor of the one or more processors is configured to cause the ambient IoT device to:
receive, in a second reference signal symbol, a second ambient IoT waveform multiplexed with the UE reference signal.

10. The apparatus of claim 9, wherein the one or more ambient IoT control channel communications include an indication of a timing location of the second reference signal symbol.

11. The apparatus of claim 9, wherein at least one processor of the one or more processors is configured to cause the ambient IoT device to:
discard the second reference signal symbol, or
decode the second ambient IoT waveform.

12. An apparatus for wireless communication at a user equipment (UE), comprising:
one or more memories storing processor-executable code; and
one or more processors coupled with the one or more memories, at least one processor of the one or more processors configured to cause the UE to:
receive a configuration associated with multiplexing of ambient internet of things (IoT) waveforms and UE reference signals;
receive, in a reference signal symbol, an ambient IoT waveform multiplexed with a UE reference signal; and
decode the UE reference signal in accordance with the configuration.

13. The apparatus of claim 12, wherein the ambient IoT waveform comprises an on state and an off state during the reference signal symbol and carries ambient IoT information.

14. The apparatus of claim 13, wherein the ambient IoT waveform comprises an on-off keying (OOK) waveform.

15. The apparatus of claim 13, wherein the at least one processor, to cause the UE to decode the UE reference signal, is configured to cause the UE to decode the UE reference signal in accordance with one or more timing locations associated with the on state and the off state.

16. The apparatus of claim 13, wherein the reference signal symbol is a first reference signal symbol, and the ambient IoT waveform is a first ambient IoT waveform, wherein at least one processor of the one or more processors is configured to cause the UE to:
receive, in a second reference signal symbol, a second ambient IoT waveform multiplexed with the UE reference signal.

17. The apparatus of claim 16, wherein the second ambient IoT waveform comprises an opposite-state waveform relative to the first ambient IoT waveform and carries the ambient IoT information.

18. The apparatus of claim 16, wherein the at least one processor, to cause the UE to decode the UE reference signal, is configured to cause the UE to decode the UE reference signal in accordance with one or more first timing locations associated with the on state and the off state during the first reference signal symbol and one or more second timing locations associated with an on state and an off state during the second reference signal symbol.

19. An apparatus for wireless communication at a network node, comprising:
one or more memories storing processor-executable code; and
one or more processors coupled with the one or more memories, at least one processor of the one or more processors configured to cause the network node to:
transmit one or more ambient internet of things (IoT) control channel communications associated with multiplexing of ambient IoT waveforms and user equipment (UE) reference signals;
transmit a configuration associated with the multiplexing of the ambient IoT waveforms and the UE reference signals; and
transmit, in a reference signal symbol, an ambient IoT waveform multiplexed with a UE reference signal in accordance with the one or more ambient IoT control channel communications and the configuration.

20. The apparatus of claim 19, wherein a timing location of the reference signal symbol is associated with an ambient IoT packet transmission.
